(19) United States
(12) Patent Application Publication
(10) Pub. No.: US 2008/0195623 A1
(43) Pub. Date: Aug. 14, 2008

(54) Risk management system

(75) Inventors: Ralph J. Simon, Binghamton, NY (US); Daniel J. Wright, Vestal, NY (US)

Correspondence Address: TAROLLI, SUNDHEIM, COVELL & TUMMINO LLP;Suite 1700, 1300 East Ninth Street, CLEVELAND, OH, 44114, US

(73) Assignee: Lockheed Martin Corporation

(21) Appl. No.: 11/705,931

(22) Filed: Feb. 14, 2007

(51) Int. Cl. G06F 17/30

(52) U.S. Cl. 707/9

(57) ABSTRACT

A system manages risks. The system includes a processor for executing the system. A risk manager determines a team structure. The risk manager has the ability to lock/unlock a database to external users. A team administrator creates a risk team. The team administrator is notified when the database is locked to the external users. The processor provides at least two access levels for the external users. The access levels allow external user access to only a single program at a time.

### FIELD OF INVENTION

The present invention relates to a risk management system, and more particularly, to a risk management system with access by users.

### BACKGROUND OF THE INVENTION

Conventional businesses are subject to a variety of risks intrinsic to their operations. Thus, these businesses typically categorize and manage these through a comprehensive and consistent framework. The framework may be calibrated to the nature of the risks and the institution within which these risks occur.

Conventional enterprise risk management is derived from enterprise objectives within the context of a business unit hierarchy. Low-level managers are expected to align these enterprise objectives with day-to-day operations.

### SUMMARY OF THE INVENTION

A system in accordance with the present invention manages risks. The system includes a processor for executing the system. A risk manager determines a team structure. The risk manager has the ability to lock/unlock a database to external users. A team administrator creates a risk team. The team administrator is notified when the database is locked to the external users. The processor provides at least two access levels for the external users. The access levels allow external user access to only a single program at a time.

A computer program product in accordance with the present invention manages risks. The computer program product includes: a first instruction for determining a team structure; a second instruction for locking/unlocking a database to external users; a third instruction for creating a risk team; a fourth instruction for notifying a team administrator when the database is locked to the external users; a fifth instruction for providing at least two access levels for the external users; and a sixth instruction for allowing external user access to only a single program at a time.

Another computer program product in accordance with the present invention manages risks. The computer program product includes: a first instruction for determining a team structure; a second instruction for locking/unlocking a database to external users; a third instruction for creating a risk team; a fourth instruction for notifying a team administrator when the database is locked to the external users; a fifth instruction for providing at least two access levels for the external users; a sixth instruction for allowing external user access to only a single program at a time; and a seventh instruction for updating a table of authorized external users.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of a risk management system in accordance with the present invention;

FIGS. 2A & 2B are a schematic representation of an example risk assessment screen for the risk management system of FIG. 1;

FIG. 3 is a schematic representation of example calculations for the risk management system of FIG. 1;

FIG. 4 is a schematic representation of an example control/action item data entry screen for the risk management system of FIG. 1;

FIG. 5 is a schematic representation of an example risks status report for the risk management system of FIG. 1;

FIG. 6 is a schematic representation of an example risk summary report for the risk management system of FIG. 1;

FIGS. 7A & 7B are a schematic representation of an example risk data sheet report for the risk management system of FIG. 1;

FIG. 8 is a schematic representation of an example customized report for the risk management system of FIG. 1; and

FIG. 9 is a schematic representation of an example computer program product in accordance with the present invention.

### DESCRIPTION OF AN EXAMPLE EMBODIMENT

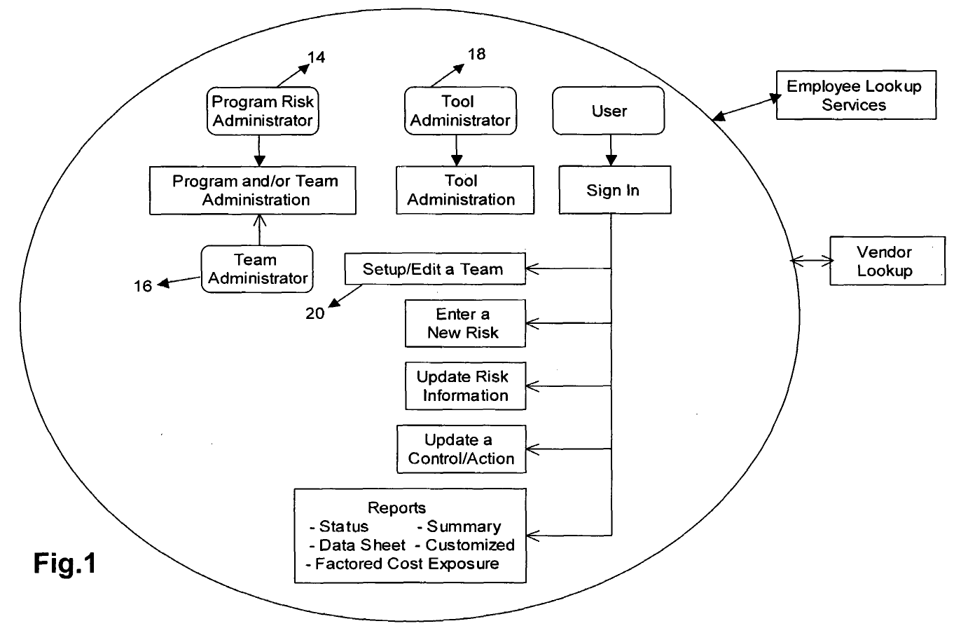

A risk management system 10 in accordance with the present invention may provide a user id and password authentication check for accessing the risk management system (FIG. 1). The system 10 may verify that the User Id and the password are valid. If invalid, the system 10 may display an appropriate error message. The system 10 may set a variable to be used throughout the system to verify that the User Id is valid and check for validity upon invocation of each WEB page. If the User Id defines a risk management tool administrator 18, then the system 10 may provide him/her with a link to predetermined administrator functions.

The system 10 may be available to several corporate locations for access to the system. Information and tool administration may be segregated per location. The system 10 may validate all input data, per a predetermined format, prior to committing to a database.

The tool administrator 18 may define the overall configuration of the system 10. Inputs to the system 10 by the tool administrator 18 include: Business Area—listing of business areas; Business Area executives and associated staff—listing of users identified with “guest” authority to view risk reports within a give business Area; Process Owners—listing of users identified with authority to view risks reports across all business area's; Programs—listing of authorized programs; News Maintenance—screen which allows updating of the News & Information web page; Location Setup—enables partitioning of the application for other corporate locations;

The tool administrator 18 may define specific program configurations. Inputs to the system 10 by the tool administrator 18 for program configuration include program name, selection of program setup options, external user access levels, authorized program team approvers, risk manager (or designee), and the external user identifier—person with authority to assign external users to the program.

The tool administrator 18 may have overarching system level authority to approve new teams, update team setup information, delete teams, delete risks, and to delete control/actions.

A program risk administrator 14 (risk manager or designee) may determine how risks shall be managed within a program and determine a team structure. This determination may enable the risk administrator 14 to identify and setup risks teams. An individual that creates risk teams may be termed a team administrator 16 (TA). The system 10 enables a TA 16 to setup and edit a team via the Setup/Edit a Team data entry function link. This function allows the TA 16 to assign internal team members, select advanced/optional fields, etc. A TA 16 may assign external users to the team when both program setup options allow and externals have been assigned to the program by the External User Identifier. A TA 16 may access this function from a Team Setup form.

Inputs by the TA 16 to the system 10 may include: Team Name—data entry field; Business area associated with the team—dropdown menu; Program—dropdown menu; Project—data entry field with previously defined dropdown menu; Team Administrator—data entry field; and Team Members—data entry field. Team members may be internal and or external users that are verified by the system 10 as valid internal and external users. External user team members may be assigned when program setup options allow.

For each of the team members assigned, the TA 16 may select: Read or Write Access—write access allows viewing and updating of risk information while read access limits access to viewing of risk within the program); Notify—check box that if selected sends notification to the team member when assigned a control/action item. The program's External User Identifier may control external user access level on the program using the Define External User data entry form. Inputs to the system 10 Define External User form may include; Program (dropdown menu); External user name—data entry field which must match external users entered into a special directory server; Expanded Access—check box that if selected will provide the external user with expanded access; Limited Report View—check box that if selected will provide the external user with a very limited view of information.

The program risk administrator 14 notifies the Tool Administrator 18 of individuals given authority to approve new teams being setup against the program. The risk Tool Administrator 18 will enter program team approvers in the program setup screen. Program team approvers may receive emails of new teams requesting their approval by a TA 16. The email may include team member names, administrator name, team name, project name, and program name. The program Team Approver may confirm or reject team formation and enter comments. The decision, along with pertinent comments, is automatically emailed to the TA 16.

A Team Setup form may also provide a Team Administrator 16 ability to select advanced fields to be displayed on pertinent program screens, and to provide a Select button if program is not listed. Actuation of the Select button may produce a display note with instruction to contact the Tool Administrator 18 to update the program listing. An email note may be automatically sent to the Team Approver when the team setup configuration is saved for the first time. The email note will request the team approver to review the team configuration and to approve if acceptable. The system 10 may send an email note to a TA 16 announcing the decision.

A TA 16 may setup, modify, or deactivate assigned teams by selecting the Setup/Edit a Team data entry function link. Selection of this link will displays a listing of assigned teams along with an Add New Team link. The TA 16 may select Edit for any of the assigned teams and update as needed. The team may be deactivated by deleting the active “check” mark. If the TA 16 attempts to delete a team member that is assigned to an open risk or control/action, the system 16 may display a note indicating that the team member cannot be deleted unless the risk control action is reassigned or the risk is closed.

The system 10 may send an email to the TA 16 with copy to the Tool Administrator 18, if data update has not been conducted within a predetermined time (i.e., 6 months) for risks associated with a given team. Emails may include comments to deactivate team if no longer active.

The system 10 may request an external user entering the application to select which assigned program to enter if assigned to multiple programs. The system 10 may allow external users to enter, update, and view information according to their access level restrictions. External users may access one program at a time. External users may be provided a search screen to filter data input records and to sort and filter report information. If the external user is not assigned to any team, the user may be provided with a message that reads: “User cannot view data/information since user is not currently assigned to a team”.

The system 10 may allow internal users the ability to access multiple programs as desired in accordance with their access rights. Internal users may be provided with a search screen to filter input data and to sort and filter report data. If the internal user is not assigned to a team, the user may be provided with a message that reads: “User cannot view data/information since user is not currently assigned to a team”.

The system 10 may provide internal and external users, with applicable access rights, the ability to roll up risks to the project or the program level, and thus view all risks associated with the project or the program. Users may not be able to view risks from programs that they are not assigned.

The system 10 may restrict users given read authority on a team, from entering data against that team. The system 10 may recognize internal Business Area Guests and Process Owner Guests. These individuals are given authority to view risks within an assigned business area or across business areas respectively. Guests may be given viewing access by the tool administrator 16.

The system 10 may provide a risk data entry form to record and update new risks. An “Enter a New Risk” function link may activate a blank risk data entry form. The risk data entry form may include a section for risk identification, risk assessment and risk control/actions.

Risk identification data entry fields for the system 10 may include Risk Number, Originator (field is integrated to the Lookup table), Date Opened, State—dropdown showing Open (default), Discarded, and Closed, Title, Consequences, Cost Impact in Dollars, Schedule Impact in days, Owner—dropdown list of applicable team members, Team, Date Closed, Closure Notes, Closure Approver—dropdown list of applicable team members, Comments, and Supplier/subcontractor—field is linked to the organizations Vendor Table. An optional advanced screen field for this function of the system 10 may be the Cause field. The form may be saved after a set of mandatory fields are completed, or the user may advance to the assessment or control/actions portion of the form.

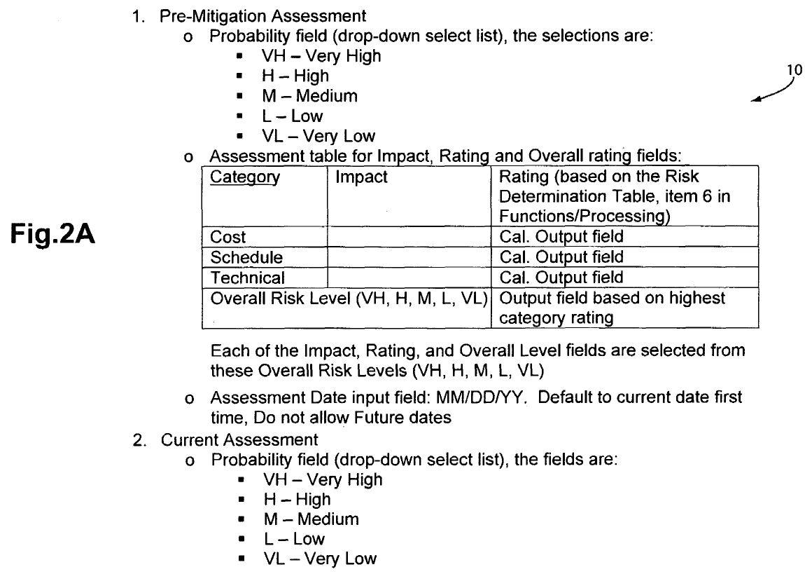

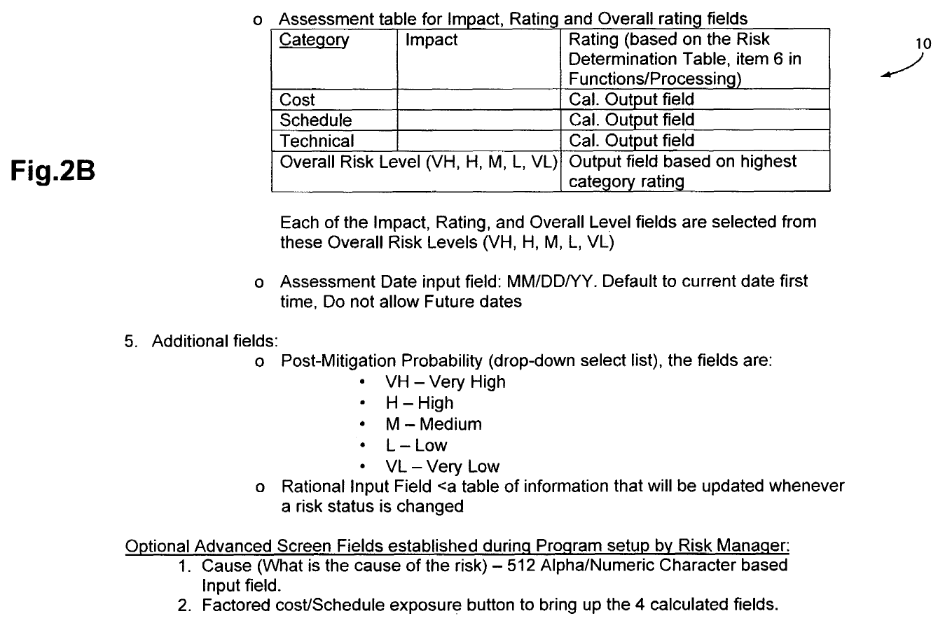

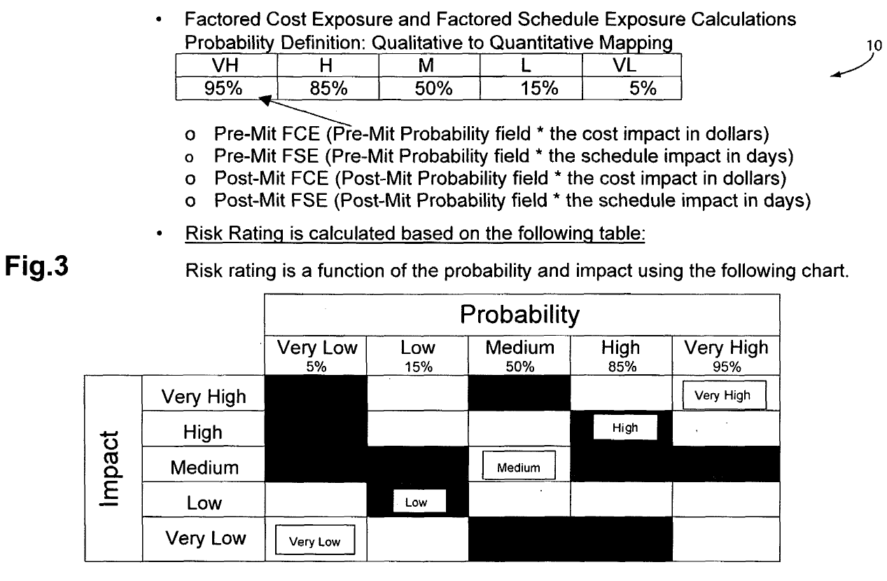

The assessment portion of the data entry form provides the ability to enter pre-mitigation and post-mitigation assessment information (FIGS. 2A & 2B). Current assessment information is automatically registered when the data entry form is saved. In this case, the system 10 will copy the pre-mitigation assessment information into the current assessment fields System assessment calculations are shown in FIG. 3.

Pre-mitigation assessment data entry fields for the system 10 may include a set of dropdown selections for Probability, along with Technical, Cost, and Schedule Impact. The system 10 may calculate Pre-mitigation Risk Rating Levels and the Overall Risk Level using the previously defined values. The system 10 may calculate Pre-mitigation Factored Cost Exposure and Pre-mitigation Schedule Exposure values based upon previously entered information.

Post-mitigation fields include a Probability dropdown selectable field and data entry fields for Cost Impact and Schedule Impact. These fields are used to calculate Post-mitigation Cost Exposure and Post-mitigation Schedule Exposure levels. System assessment calculations are shown in FIG. 3.

The system 10 may include a comments/rationale field to record the basis of the initial assessment or changes to the assessment. Comments/rationale entries are saved in a comments/rationale history table as separate records. The records may be updated within a system defined time window via the Comments/Rationale View History link.

The system 10 assessment data entry form may provide probability and impact assessment criteria table links to aid in the assessment process. The system 10 may require all assessment fields to be populated before the information can be saved to the database. The system 10 may validate all input data prior to committing to the database.

The Control/Action portion of the data entry form provides the ability to enter a set of control/action steps to handle or reduce the risk over time. The system 10 may require control/action step data entry fields to include Action Id, Action Owner—dropdown listing of applicable team members, Action Start Date—defaults to current data); Next Status Date, Target Close Date, Actual Close Date, Cost to Implement, Mitigation—Checkbox, Contingency—Checkbox, Avoidance—Checkbox, Action Plan, Status and Projected Risk Level. Status entries may be stored as separate records in a history table upon saving of the risk. The status table includes the name of the user adding the status and a date stamp. The Status record may be updated within a system defined time window. Status records may be viewed via selection of the Action Status View History link.

The system 10 may provide an Update Risk Information function link to enable users with write authority to update previously entered risk information in the risk data entry form. This function may display the previously populated risk data entry form with the addition of a current assessment set of data entry fields. When the Update Risk Information function link is selected, a search screen may be displayed to enable filtering of the information. The system 10 may include search functions for risk owner, action owner, team, program, project, risk state, action state, and risk identification number.

The current assessment section of the risk data entry form may include a set of dropdown selections for Probability, along with Technical, Cost, and Schedule Impact assessment. The system 10 may calculate Current Risk Rating Levels and the Overall Risk Level using the previously defined values. These fields are provided to show and compare current assessment levels against planed levels as defined by the set of control/action steps.

The system 10 update risk data entry form may show a listing of Risk Options which includes three scrolling links—Risk Identification, Risk Assessments, and Risk Control/Actions, and a New Search link. The risks data entry form may also include a Risk Lookup field. The Risk Lookup field—dropdown list of applicable risks, allows the user to select which risk to display for review and update. The Risk Options and Risk Lookup information will be displayed when updating previously entered risks.

When an existing risk status is changed to ‘Closed’, the system 10 may verify that there are no open control/actions against this risk. If there are open control/actions, the system 10 may alert the user that the risk cannot be closed until all of the control/actions related to the risk are closed.

When a risk is closed, the system 10 may require a user to input closure notes and to identify an approver from a drop down menu of team members. When the risk is closed, the system 10 may propose questions, such as please rate your satisfaction with the usability and functionality of the RISK MANAGEMENT tool: Very Satisfied (1), Satisfied (2), Neutral (3), Dissatisfied (4), Very Dissatisfied (5).

The system 10 may inquire whether a user wishes to close a risk when the last open action item is changed to closed. If “yes”, the system 10 may navigate the user to the State field for update.

The System 10 may allow the user to open a closed risk. If this occurs, the system 10 may inquire a rationale be documented in a closed/discarded notes field.

The system 10 may validate all input data prior to committing to the database. The system 10 may verify that all system calculations are properly executed and that correct data output is provided to a user when the record is saved.

The system 10 may notify a team member of a newly assigned control/action assigned per registration designation. The note may include Program, Project, Team Name, Action ID Number, and text of the corresponding action plan.

When entering an Action Actual Close Date, the system 10 may check the risk status of all actions. If all actions are closed, the system 10 may query a user whether to close out the risk. If yes, the system 10 may display a Risk Identification Screen so that a user may close the risk.

The system 10 may provide a Help button to display field level help on a data entry form. The system 10 may provide a message alert function. Notice may be sent to a risk action owner 10 days prior to the target close date.

When action is closed, the system 10 may query a risk action owner whether to update current assessment now that the action is closed. If yes, the system 10 may display a current assessment section of the assessment screen. The system 10 may enter many control/action steps per one risk. If a user attempts to close a risk containing open control/action steps, the system 10 may query a user to close the open control action steps.

When a Target Close Date is changed, the system 10 may display an original target close date along with a new target close date. The system 10 may date stamp Target Close Date Changes and force a comment in a status history file.

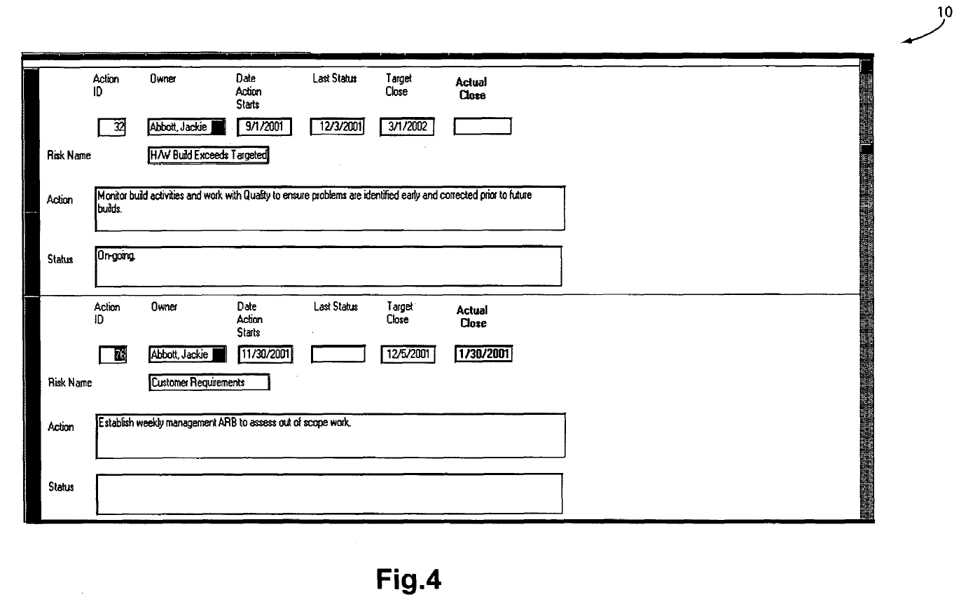

The system 10 may provide a mechanism to allow the user to view and update control/action step information using the Update Control/Actions function (FIG. 4) link. When the Update Control/Actions function is selected from the main menu, a sorting and filtering screen will be displayed.

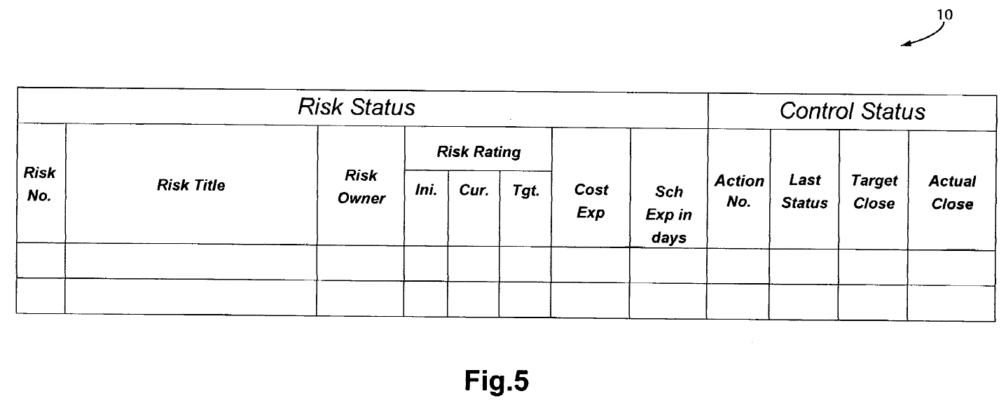

System 10 Update Control/Actions sorting options may include Action Owner, Overall Risk Level—Pre/Post-mitigation or Current, Target Risk Level, Target Close Date, Next Status Date, Pre-Mitigation Factored Cost or Schedule Exposure, and/or Post-mitigation Factored Cost or Schedule Exposure (FIG. 5). The system 10 Update Control/Actions function may include filtering options: Program—drop-down list containing programs the user is currently assigned to; Project—drop-down list containing projects associated with assigned programs; Team—dropdown list containing user assigned teams with write access; Open Actions that are past a Target Close Date—check box; Action Owner—drop-down listing of team members; and Risk State—dropdown selection list of Open, Discarded, and Closed.

The system 10 may provide a user with the ability to generate a high level Risk Status Report of Risks in accordance with access rights. This high level report may provide sorting and filtering capability. The system 10 may generate a Risk Status Report by selecting a generate button. The system 10 may provide ability to export risk status data into HTML, Microsoft Word, or Microsoft Excel. The system 10 may further provide ability to email reports.

The system 10 may provide sort options by Risk Owner, Action Owner, Overall Risk Level—Pre/Post-mitigation or Current, Cost or Schedule Impact, and/or Vendor. The system 10 may provide filtering options, including, but not limited to: Programs—Dropdown listing or user assigned programs; Project dropdown list containing projects related to assigned programs; Team—dropdown list containing teams related to assigned programs; Pre-mitigation Risk Level—dropdown listing of applicable risk levels; Post-mitigation Risk Level—Dropdown listing of applicable risk levels; Risk Owner and Action Owner—dropdown listing of individuals related to assigned teams; Risk State—dropdown selection list—that defines risk states such as Open, Discarded, and Closed; and/or Technique—Mitigation, Avoidance, or Contingency selection. The system 10 may further provide ability to select multiple user assigned Programs, Projects, Teams, Pre-mitigation Risk Levels, and/or Post-mitigation Risk Levels from the filtering dropdowns.

The system 10 may provide a user with the ability to generate a high level report with added control/action descriptions in accordance with user access rights. This Risk Summary Report may provide sorting and filtering capability.

The system 10 may generate a Risk Summary Report by selecting a generate button. The system 10 may provide ability to export risk status data into HTML, Microsoft Word or Microsoft Excel,. The system 10 may further provide ability to email reports.

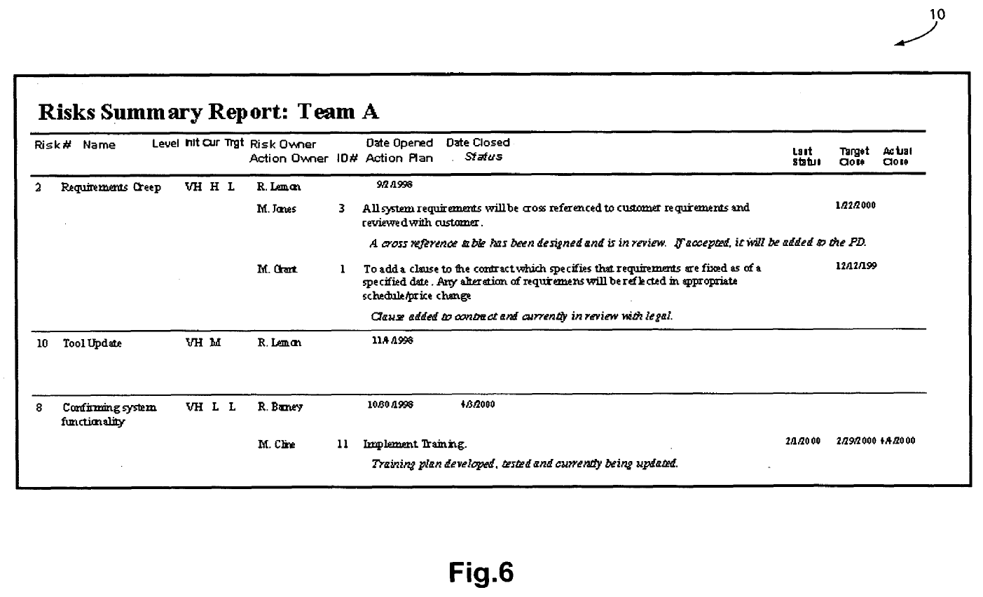

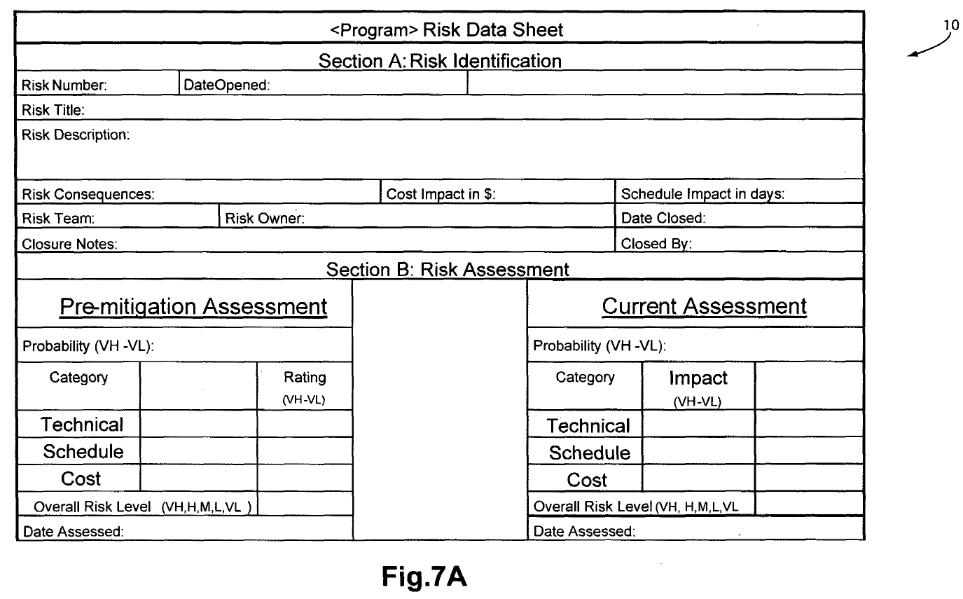

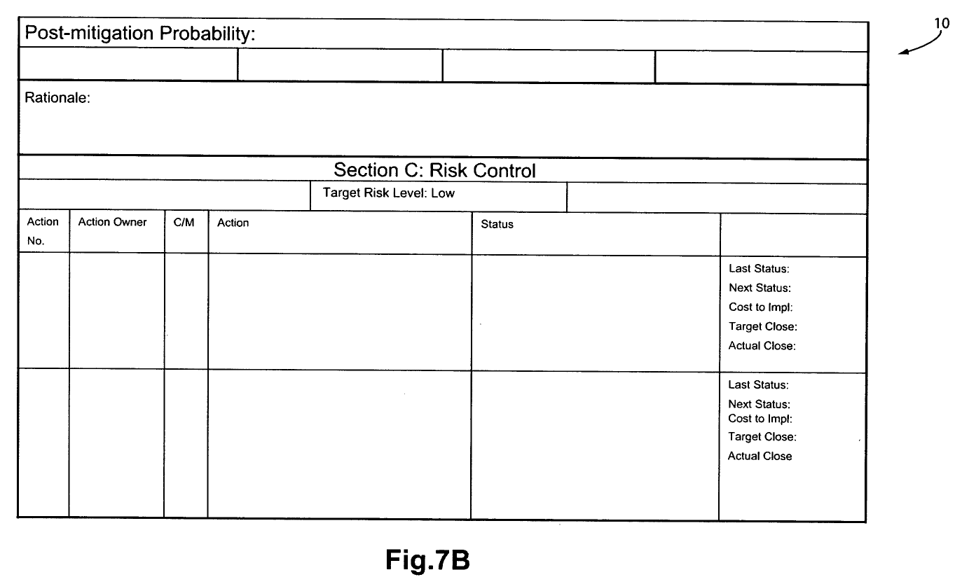

The system 10 may sort options by Risk Owner, Action Owner, Target Close Date—closest date first, Next Status Date, Overall Risk Level—Pre/Post-mitigation or Current, Cost or Schedule Impact, and/or Vendor. The system 10 may filter Programs—Drop-down listing by programs user assigned to, Projects—drop-down list related to assigned programs, Teams—dropdown list related to assigned programs, Pre-mitigation Risk Levels—dropdown of applicable risk levels; Post-mitigation Risk Levels—dropdown of applicable options, Risk Owners, Action Owners—dropdown of individuals per assigned teams, Risk States—dropdown selection list defining risk states such as Open, Discarded, and Closed, and/or Techniques—dropdown listing by Mitigation, Avoidance, Contingency. The system 10 may further provide ability to select multiple Programs, Projects, Teams, Pre-mitigation Risk Levels, and/or Post-mitigation Risk Levels from the filtering dropdowns. The system 10 may thus output a Risk Summary Report (FIG. 6).

The system 10 Risk Summary Report may include additional fields such as Cost Impact, Schedule Impact, and action item fields such as Next Status Date, Last Status Date, Target Close Date, Actual Close Date, Action Item description, Status, and Cost to Implement., The system 10 may provide a user with the ability to generate individual Risk Data Sheets. These Risk Data Sheets may provide sorting and filtering capability.

The system 10 may generate a Risk Data Sheet for one or more risks. The system 10 may provide ability to export risk status data into HTML, or Microsoft Word formats. The system 10 may further provide ability to email reports and provide a blank datasheet form that may be printed as a hardcopy for team use.

The system 10 may sort the Risk Data Sheet report information by Risk State, Program, Project, Team, or Phase. The system 10 may filter the Risk Data Sheet report information by Program—dropdown listing of assigned programs, Project—dropdown listing of projects related to assigned programs, Teams—dropdown list of teams related to assigned programs, and Risk States—dropdown selection list defining risk states such as Open, Discarded, and Closed. The system 10 may allow user to select the desired risk to view from a listing of filtered risks. The listing of filtered risks may display risk ID, title, and associated team.

The system 10 may provide a user with the ability to generate a Cost Report of Pre/Post-mitigation Factored Cost Exposure. This report may provide sorting and filtering capability.

The system 10 may generate a Factored Cost Exposure Report by selecting a generate button. The system 10 may provide ability to export risk status data into HTML, Microsoft Word, or Microsoft Excel formats. The system 10 may provide ability to email reports.

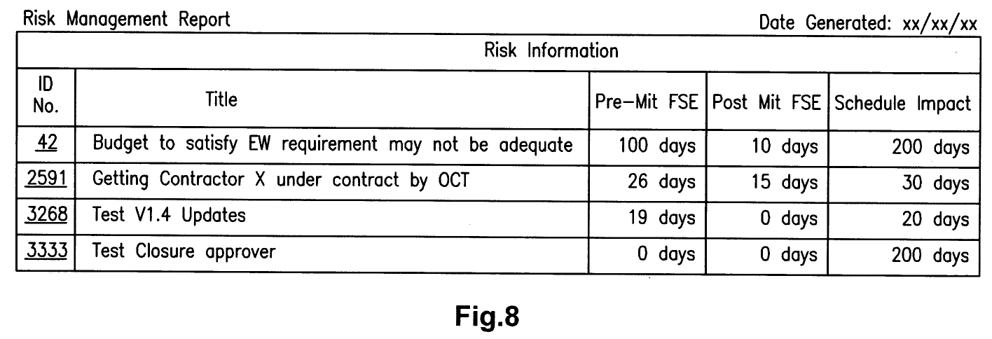

The system 10 may sort Factored Cost Exposure Report information by Pre-mitigation Cost Impact, Pre or Post-mitigation Factored Cost Exposure, Cost to Mitigate, and/or Total Cost Exposure. The system 10 may filter Factored Cost Exposure Report information by Program dropdown listing by assigned programs, Project—dropdown list containing projects related to assigned program, Teams—dropdown list of teams related to assigned programs, Top N risks with largest Pre-mitigation Factored Cost Exposures, and/or Risk States—dropdown selection list defining risk states such as Open, Discarded, and Closed. The system 10 may thus output a Factored Cost Exposure Report (FIG. 8).

The system 10 may display a listing of access controlled Data Entry option links. Data Entry options include Enter a New Risk, Update Risk Information, Setup/Edit a Team, Update Control/Action, and Site Lesson Learned. The system 10 may display a listing of access controlled Reporting option links including Risk Status Report, Summary Report, Data Sheet, Factored Cost Exposure Report, Scatter Diagram, and View Teams report.

The system 10 may provide a Tool Administrator 18 with special functions including News Maintenance, Business Area Maintenance, Program List Maintenance, Process Owner Maintenance, and Survey Results. These functions may be user selectable from the Risk Administrator Options Page. The system 10 may provide the Tool Administrator 18 the ability to generate special Team Listing report. The system 10 may provide the Team Listing Report with many sorting options, filtering options and an assortment of selectable data fields for viewing. Filtering options include the From Date & To Date Team was Created, Team Status, Programs, Projects, and Business Areas. The system 10 may sort Program Short Names, Program Long Names, Team Names, and Business Areas.

The system 10 may generate the Team Listing Reports by selecting a generate button. A Team Listing Report may include Program Name, Project Name, Team Name, Team Administrator, Date team was created, Team Status, and/or Number of open/closed risks and an edit field.

Selection of the edit field from the Report may show the following information: Program Name, Team name, Project Name, Listing of Team Members, and Authority level of each individual,

The system 10 may further allow the Team Listing Report to be filtered by activity status of the teams. This option may show a listing of programs/projects/teams that have or have not actively updated the database over a specified time period.

The system 10 may provide an Email function to enable the user to send the Tool Administrator 18 email notes/questions. The system 10 may provide external interfaces to other systems. As an example, these other systems may be used for user authentication (FIG. 1).

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

As stated above and as shown in FIG. 1, a system 10 in accordance with the present invention manages risks. The system 10 includes a processor for executing the system. A risk manager 14 determines a team structure. The risk manager 14 has the ability to lock/unlock a database to external users. A team administrator 16 creates a risk team 20. The team administrator 16 is notified when the database is locked to the external users. The processor provides at least two access levels for the external users. The access levels allow external user access to only a single program at a time.

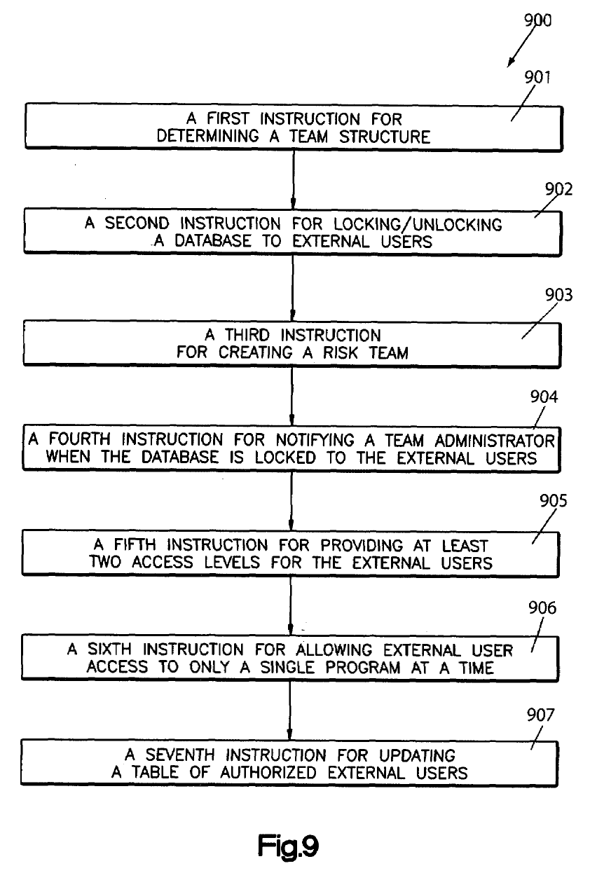

A computer program product 900 in accordance with the present invention manages risks (FIG. 9). The computer program product 900 includes: a first instruction 901 for determining a team structure; a second instruction 902 for locking/unlocking a database to external users; a third instruction 903 for creating a risk team 20; a fourth instruction 904 for notifying a team administrator 16 when the database is locked to the external users; a fifth instruction 905 for providing at least two access levels for the external users; and a sixth instruction 906 for allowing external user access to only a single program at a time.

Another computer program product 900 in accordance with the present invention manages risks (FIG. 9). The computer program product 900 includes: a first instruction 901 for determining a team structure; a second instruction 902 for locking/unlocking a database to external users; a third instruction 903 for creating a risk team 20; a fourth instruction 904 for notifying a team administrator 16 when the database is locked to the external users; a fifth instruction 905 for providing at least two access levels for the external users; a sixth instruction 906 for allowing external user access to only a single program at a time; and a seventh instruction 907 for updating a table of authorized external users.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for managing risks, said system comprising:
a processor for executing said system;
a risk manager for determining a team structure, said risk manager having the ability to lock/unlock a database to external users; and
a team administrator for creating a risk team, said team administrator being notified when said database is locked to the external users,
said processor providing at least two access levels for the external users, said access levels allowing external user access to only a single program at a time.

2. The system as set forth in claim 1 wherein said risk manager determines a structure for the risk team.

3. The system as set forth in claim 1 wherein said team administrator inputs a team name, team members, and a business area for the risk team.

4. The system as set forth in claim 1 wherein team members may be authorized for “read only” or “read and write”.

5. The system as set forth in claim 1 wherein said team administrator deactivates the risk team.

6. A computer program product for managing risks, said computer program product comprising:
a first instruction for determining a team structure;
a second instruction for locking/unlocking a database to external users;
a third instruction for creating a risk team;
a fourth instruction for notifying a team administrator when the database is locked to the external users;
a fifth instruction for providing at least two access levels for the external users; and
a sixth instruction for allowing external user access to only a single program at a time.

7. The computer program product as set forth in claim 6 further including a seventh instruction for updating status of the risk team.

8. The computer program product as set forth in claim 6 further including a seventh instruction for deactivating a risk team.

9. The computer program product as set forth in claim 6 further including a seventh instruction for determining whether a user is assigned to multiple programs, multiple projects, and multiple teams.

10. The computer program product as set forth in claim 6 further including a seventh instruction for recognizing a guest that is not a member of the risk team.

11. A computer program product for managing risks, said computer program product comprising:
a first instruction for determining a team structure;
a second instruction for locking/unlocking a database to external users;
a third instruction for creating a risk team;
a fourth instruction for notifying a team administrator when the database is locked to the external users;
a fifth instruction for providing at least two access levels for the external users;
a sixth instruction for allowing external user access to only a single program at a time; and
a seventh instruction for updating a table of authorized external users.

12. The computer program product as set forth in claim 11 further including an eighth instruction for varying levels of authority of the authorized external users.

13. The computer program product as set forth in claim 11 further including an eighth instruction for varying the access to the database of an external user.
